(19) United States
(12) Patent Application Publication
(10) Pub. No.: US 2026/0145708 A1
(43) Pub. Date: May 28, 2026

(54) VEHICLE CONTROL DEVICE AND METHOD OF CONTROLLING VEHICLE

(71) Applicants: Hyundai Motor Company, Seoul (KR); Kia Corporation, Seoul (KR)

(72) Inventors: Sung Woo Jang, Hwaseong-si (KR); Min Sung Kim, Hwaseong-Si (KR); Sung Kwan Kim, Hwaseong-Si (KR); Seung II Han, Hwaseong-Si (KR); Ji Hong Kim, Hwaseong-Si (KR); Dong Gyu Kim, Hwaseong-Si (KR); Sung Hwan Yun, Hwaseong-Si (KR)

(21) Appl. No.: 19/249,774

(22) Filed: Jun. 25, 2025

(30) Foreign Application Priority Data
Nov. 25, 2024 (KR) 10-2024-0169444

(51) Int. Cl. B60W 60/00; B60W 30/09; B60W 30/095; B60W 30/16; B60W 50/00; B60W 50/14

(52) U.S. Cl. CPC B60W 60/0015; B60W 30/09; B60W 30/0956; B60W 30/16; B60W 50/0097; B60W 50/14; B60W 60/00274; B60W 2050/146; B60W 2554/4041; B60W 2554/4042; B60W 2554/4045; B60W 2554/80

(57) ABSTRACT

Provided is a device for controlling a vehicle. The device may include one or more processors and a memory. The memory may store at least one instruction that is configured, when executed by the one or more processors communicating with the memory, to cause the device to: determine, based on an external object detected by one or more sensors of the vehicle, movement of the external object; determine, based on the movement of the external object, based on vehicle driving information of the vehicle, and based on a safety boundary between the vehicle and the external object, a driving path of the vehicle; and control, based on the driving path, an autonomous driving operation of the vehicle.

### CROSS-REFERENCE TO RELATED APPLICATION

This application claims priority to Korean Patent Application No. 10-2024-0169444, filed on Nov. 25, 2024, the disclosure of which is incorporated herein by reference in its entirety.

### FIELD

The present disclosure relates to a vehicle control device and a method of controlling a vehicle.

### BACKGROUND

Model predictive control (MPC) is a control technique that plays a key role in some route planning and control of autonomous vehicles. Model predictive control may allow prediction of future driving trajectories and determination of an optimal driving route while satisfying various constraint conditions. Model predictive control may allow vehicles to travel more safely and more efficiently.

However, in a heavy traffic situation or when there are many vehicles around, in order to cope with scenarios where the vehicle needs to navigate through narrow spaces by taking actions such as avoiding vehicles, cutting in between vehicles, and the like, it may be a challenging task to create a safe route in uncertain situations because it may require the vehicle to consider the movements of surrounding vehicles, accuracy of sensors, and the like.

The matters described in this Background section are only for enhancement of understanding of the background of the disclosure, and should not be taken as acknowledgement that they correspond to prior art already known to those skilled in the art.

### SUMMARY

The present disclosure is directed to providing a vehicle control device capable of generating a safe route on which a vehicle does not collide with surrounding vehicles in an uncertain situation while traveling, and a method of controlling a vehicle.

The present disclosure is also directed to providing a vehicle control device capable of predicting a range and a route on which a vehicle can safely travel by considering both noise of a prediction model and noise of a sensor, and a method of controlling a vehicle.

According to one or more example embodiments of the present disclosure, a device for controlling a vehicle may include one or more processors and a memory. The memory may store at least one instruction that is configured, when executed by the one or more processors communicating with the memory, to cause the device to: determine, based on an external object detected by one or more sensors of the vehicle, movement of the external object; determine, based on the movement of the external object, based on vehicle driving information of the vehicle, and based on a safety boundary between the vehicle and the external object, a driving path of the vehicle; and control, based on the driving path, an autonomous driving operation of the vehicle.

The at least one instruction may be configured, when executed by the one or more processors communicating with the memory, to further cause the device to: determine, based on first object information of the external object measured via the one or more sensors at a first time, a predicted movement value of the external object; determine a measured movement value by measuring, via the one or more sensors at a second time later than the first time, second object information of the external object; and determine, based on a difference between the predicted movement value and the measured movement value, an error covariance.

The at least one instruction may be configured, when executed by the one or more processors communicating with the memory, to further cause the device to: determine, based on the first object information and the vehicle driving information, a first safety boundary between the vehicle and the external object; and determine a second safety boundary by applying the error covariance to the first safety boundary. The safety boundary between the vehicle and the external object may be determined based on the second safety boundary.

The at least one instruction may be configured, when executed by the one or more processors communicating with the memory, to cause the device to determine the first safety boundary by: determining the first safety boundary based on a position and a speed of the external object relative to the vehicle. The first safety boundary may be modeled in an elliptical shape.

The at least one instruction may be configured, when executed by the one or more processors communicating with the memory, to cause the device to determine the second safety boundary by: applying the error covariance to the first safety boundary as a margin area.

The at least one instruction may be configured, when executed by the one or more processors communicating with the memory, to cause the device to determine the driving path of the vehicle based on the second safety boundary.

The at least one instruction may be configured, when executed by the one or more processors communicating with the memory, to cause the device to determine the driving path by: determining the driving path so that the vehicle travels within the second safety boundary.

The at least one instruction may be configured, when executed by the one or more processors communicating with the memory, to cause the device to determine the driving path by: determining the driving path so that a probability that the vehicle travels within the second safety boundary is greater than or equal to a threshold value.

The at least one instruction may be configured, when executed by the one or more processors communicating with the memory, to further cause the device to: determine, based on a distance between the second safety boundary and the external object, a driving strategy.

The at least one instruction may be configured, when executed by the one or more processors communicating with the memory, to cause the device to control the autonomous driving operation of the vehicle includes: displaying, via a display device of the vehicle, an indication of the vehicle, an indication of the external object, and an indication of the safety boundary. The safety boundary may be determined based on at least one of: a first probability value associated with one or more sensing errors of the one or more sensors or a second probability value associated with one or more prediction errors of the driving path.

According to one or more example embodiments of the present disclosure, a method performed by an apparatus of a vehicle may be: obtaining, from one or more sensors of the vehicle, object information of an external object and vehicle driving information of the vehicle; determining, based on the object information, movement of the external object; determining, based on the movement of the external object, based on the vehicle driving information, and based on a safety boundary between the vehicle and the external object, a driving path of the vehicle; and controlling, based on the driving path, an autonomous driving operation of the vehicle.

Obtaining the object information may include: determining, based on first object information of the external object measured via the one or more sensors at a first time, a predicted movement value of the external object; determining a measured movement value by measuring, via the one or more sensors at a second time later than the first time, second object information of the external object; and determining, based on a difference between the predicted movement value and the measured movement value, an error covariance.

The method may further include: determining, based on the first object information and the vehicle driving information, a first safety boundary between the vehicle and the external object; and determining a second safety boundary by applying the error covariance to the first safety boundary. The safety boundary between the vehicle and the external object may be determined based on the second safety boundary.

Determining of the first safety boundary may include: determining the first safety boundary based on a position and a speed of the external object relative to the vehicle. The first safety boundary may be modeled in an elliptical shape.

Determining the second safety boundary may include: applying the error covariance to the first safety boundary as a margin area.

Determining the driving path may include: determining the driving path of the vehicle based on the second safety boundary.

Determining the driving path may include: determining the driving path so that the vehicle travels within the second safety boundary.

Determining the driving path may include: determining the driving path so that a probability that the vehicle travels within the second safety boundary is greater than or equal to a threshold value.

The method may further include: determining, based on a distance between the second safety boundary and the external object, a driving strategy.

According to one or more example embodiments of the present disclosure, a vehicle may include: one or more sensors; one or more processors; and a memory. The memory may store at least one instruction that is configured, when executed by the one or more processors communicating with the memory, to cause the vehicle to: determine an autonomous driving path of the vehicle; determine, based on an external object detected by the one or more sensors, movement of the external object; determine, based on the movement of the external object and based on vehicle driving information of the vehicle, a safety boundary between the vehicle and the external object; adjust, based on the safety boundary, the autonomous driving path; and control, based on the adjusted autonomous driving path, an autonomous driving operation of the vehicle. The safety boundary may be determined based on at least one of: a first probability value associated with one or more sensing errors of the one or more sensors or a second probability value associated with one or more prediction errors of the autonomous driving path.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view showing a vehicle transmitting and receiving data by communicating with another device;

FIG. 2 is a diagram showing modules constituting a vehicle;

FIG. 3 is a diagram for describing the operation of the vehicle;

FIGS. 4 and 5 are conceptual diagrams for describing operations of a process; and

FIG. 6 is a flowchart of a method of controlling a vehicle.

### DETAILED DESCRIPTION

Hereinafter, one or more example embodiments of the present disclosure will be described in detail with reference to the accompanying drawings.

However, the technical idea of the present disclosure is not limited to the example embodiments to be described but may be implemented in various different forms, and within the scope of the technical idea of the present disclosure, one or more among components in the example embodiments may be used by being selectively combined and substituted.

Further, unless specifically defined and described, terms used in the example embodiments of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the example embodiments of the present disclosure are for the purpose of describing the example embodiments only and are not intended to limit the disclosure.

In the present specification, the singular forms may include the plural forms unless the context clearly dictates otherwise. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, when describing components of example embodiments of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

The term “unit” used in the example embodiments of the present disclosure may refer to software components or hardware components such as a field-programmable gate array (FPGA) or an application specific integrated circuit (ASIC), and “unit” performs certain functions. However, the “unit” is not limited to software or hardware. The “unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “unit” may be combined into smaller numbers of components and “units,” or may be further divided into additional components and “units.” Furthermore, the components and “units” may be implemented to reproduce one or more CPUs in a device or a security multimedia card.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining a safety boundary between a host vehicle and an external object) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining a safety boundary between a host vehicle and an external object) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining a safety boundary between a host vehicle and an external object) described herein.

Minimum risk maneuver (MRM) operation(s) may also be controlled, for example, based on one or more features (e.g., determining a safety boundary between a host vehicle and an external object) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining a safety boundary between a host vehicle and an external object) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining a safety boundary between a host vehicle and an external object) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. A car that is ahead of the ego vehicle (e.g., in the same driving lane as the ego vehicle) may be referred to as a vehicle in front, a lead vehicle, a leading vehicle, or a preceding vehicle. A car that follows the ego vehicle (e.g., in the same driving lane as the ego vehicle) may be referred to as a car behind, a trailing vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

In at least some implementations of route generation technology, route finding may rely only on critical constraint conditions to avoid collisions between vehicles. Such an approach might not be able to guarantee a sufficient level of safety because it does not sufficiently consider the movement prediction and sensor noise of surrounding vehicles.

Hereinafter, one or more example embodiments will be described in detail with reference to the accompanying drawings, but the same or corresponding components are denoted by the same reference numerals regardless of the drawing numbers, and redundant descriptions thereof will be omitted.

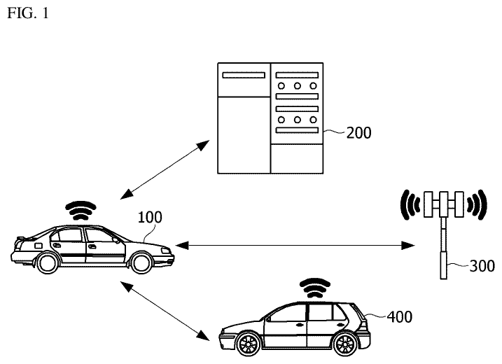

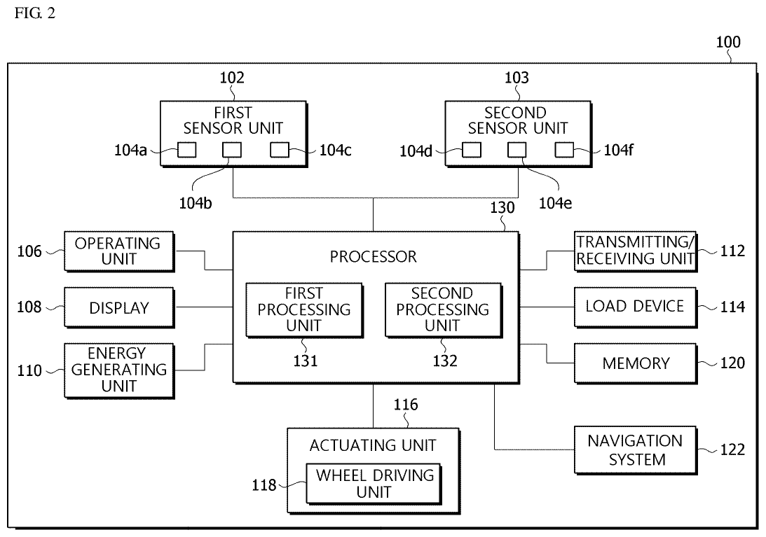

Hereinafter, a vehicle will be described with reference to FIGS. 1 and 2. FIG. 1 is a view showing a vehicle transmitting and receiving data by communicating with another device.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas in a liquefied state, for example. Here, one example of the gas may be hydrogen. However, the gas is not limited thereto, and various gases may be applicable. In the case of fossil energy, the vehicle 100 is driven based on fuel such as gasoline, diesel or liquefied gas, and may be equipped with an internal combustion engine that drives an actuating unit (also referred to as an actuator) 116 by combustion of the fuel. The engine may be included in an energy generating unit (also referred to as a generator, a power generator, an energy generator, etc.) 110 in terms of providing a driving rotational force of wheels to a wheel driving unit (e.g., a powertrain) 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but, the present disclosure may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 through 4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU). The ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a Wi-Fi communication network, a WAVE communication network, or the like, for communicating with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described example embodiments.

FIG. 2 is a diagram showing modules constituting a vehicle.

The vehicle 100 may include a sensor 102, an operating unit 106, a display 108, a load device (also referred to as a load or an electrical load) 114, and a transmitting/receiving unit (also referred to a communicator, a communication interface, a transceiver, etc.) 112.

The sensor 102 may be provided with various types of detectors to detect various states and situations occurring in an external environment, an internal system, user operation, and a boarding space of the vehicle 100.

Specifically, the first sensor 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate three-dimensional (3D) spatial information that identifies at least a shape of the external object. In order to ascertain (e.g., detect) the presence of an external object and its relative distance, speed, direction, or the like, the radar sensor 104c may emit radio waves of a specific frequency around the vehicle 100 and generate radar data through radio waves reflected from the external object. In the present disclosure, the sensor 102 is illustrated as having the lidar sensor 104b, but in other examples, the lidar sensor 104b may not be mounted.

The first sensor 102 may generate object recognition information (also referred to as object information) based on sensing data. The object recognition information may include information on the presence of an object, position information about the object, information on a distance between the vehicle 100 and the object, and information on a relative speed between the vehicle 100 and the object. External objects may be various objects related to the operation of the vehicle 100.

A second sensor 103 may be provided with a positioning sensor 104d, a wheel sensor 104e, an attitude sensor 104f, and the like, to confirm (e.g., detect, identify, sense, determine, etc.) its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (e.g., longitudinal direction x-axis), acceleration in a lateral direction (e.g., y-axis), and acceleration in a height direction (e.g., z-axis) of the vehicle 100, and a yaw, a pitch, and a roll as the angular velocity of the vehicle.

The second sensor 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit (also referred to as a user interface, a control panel, a dashboard, an instrument cluster, an instrument panel, etc.) 106. The route information may refer to information that indicates a traveling route from a current position of a host vehicle to a destination on a map, for example, after the destination has been set. If no destination is set, the route information may refer to information including a road on which the host vehicle is currently traveling and a future driving route including one or more roads. The route information may indicate which driving lane(s) for the vehicle to drive on and/or specific path(s) for the vehicle to follow along the road.

The operating unit 106 may be configured as a module (e.g., implemented as hardware, software, or a combination of both) that is controlled by the user for driving. The operating unit 106 may include any a user interface, a control panel, a dashboard, an instrument cluster, an instrument panel, etc. that a user (e.g., a driver or a passenger) may interact with to operate or manipulate one or more aspects of the vehicle 100. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that can be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 may be mounted on the vehicle 100 and may be a type of non-driving electrical device excluding a driving power system such as the wheel driving unit 118 or the like. The load device 114 may be an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, surrounding vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor 102, the operating unit 106, the display 108, the load device 114, and the transmitting/receiving unit 112, but is not limited thereto, and may include various components that implement sensing, interface, communication, and convenience functions, excluding components directly involved in driving operations. If the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. If the vehicle 100 is driven based on fossil energy, the energy generating unit 110 may be configured as an internal combustion engine. In addition, if the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit (also referred to as a navigation system) 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. The navigation unit 122 may be classified as a sub-component of the operating unit 106.

The vehicle control device may include sensors 102 and 103, a memory 120 and the processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

The processor 130 may include a first processing unit 131 and a second processing unit 132.

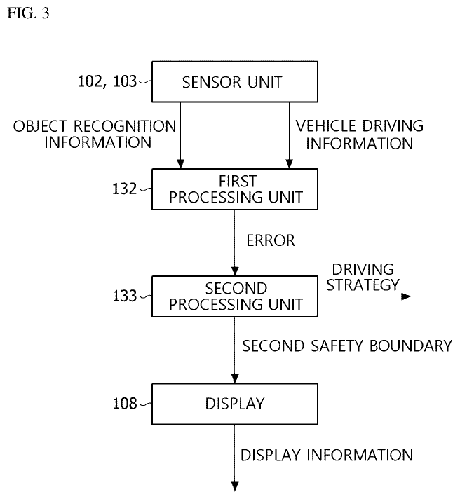

FIG. 3 is a diagram for describing the operation of the vehicle. Referring to FIG. 3, the vehicle may establish a driving record of lane keeping, lane changing, avoidance, acceleration, deceleration, and the like, by considering the noise of the sensor and the uncertainty of the surrounding vehicle's trajectory.

The first processing unit 131 may convert a location of navigation information on map information from the Cartesian coordinate system to the curvilinear coordinate system using object recognition information and vehicle driving information collected by the sensor and process the location into a form necessary for generating a driving route.

A curvilinear coordinate system-based road model may be designed based on a curvilinear (sn) coordinate system, which is based on each of a longitudinal direction (s-axis) and a lateral direction (n-axis) of the road.

The first processing unit 131 may extract (e.g., process, determine, identify, etc.) the curvilinear coordinate system-based road model corresponding to the shape of a road on which the vehicle is currently located from the map information using location information about the vehicle. The first processing unit 131 may convert pieces of state information expressed in the Cartesian coordinate system into coordinates and express the pieces of state information in the curvilinear coordinate system using the extracted curvilinear coordinate system-based road model.

Data collected by the sensor may be expressed using the Cartesian coordinate system based on (e.g., relative to) the host vehicle. This is convenient for indicating information on a relative position and a relative speed based on the host vehicle, but it is difficult to immediately determine where the measured object is located on the road or lane.

In order to address this difficulty, a road model representing a road shape may be utilized. The road model may be designed based on the curvilinear coordinate system based on each of the longitudinal direction (s-axis) and the lateral direction (n-axis) of the road. The road model utilizes mathematical curves based on measured waypoints to manage and use map information in real time.

The first processing unit 131 may extract (e.g., process, determine, identify, etc.) the shape of the road on which the host vehicle is currently located from the map information using the location information about the host vehicle, and based on the extracted shape, convert the coordinates of the aforementioned object recognition information from the Cartesian coordinate system to the curvilinear coordinate system.

The first processing unit 131 may use object recognition information to predict the movement of one or more surrounding objects (e.g., target vehicles) and calculate (e.g., determine) an error (e.g., difference, deviance, etc.) between a predicted value and a measured value. The error between the predicted value and the measured value may be caused by the measurement noise of the sensor and the process noise generated in a prediction process, and may cause inaccurate information in a process of determining a driving route.

For example, if the vehicle is traveling on the road and the trajectory or speed of a surrounding vehicle is predicted, but the actual movement of the surrounding vehicle differs from the predicted value, this difference or deviance may be defined as an error.

When (e.g., after) the object recognition information (e.g., a new set of object recognition information) is collected, the first processing unit 131 may update the error (e.g., difference, deviance, etc.) between the predicted value and the measured value to calculate error covariance.

The surrounding object may refer to a surrounding vehicle located in front or at the side of the driving route of the host vehicle, but is not necessarily limited thereto, and may refer to any static or dynamic object located around the driving route of the host vehicle.

In the example embodiments herein, for convenience of description, the surrounding object is described as a surrounding vehicle located in front of the driving route of the host vehicle by way of example.

The first processing unit 131 may predict a current state of the surrounding vehicle and update the predicted state by comparing the current state with an actual measured state. The first processing unit 131 may calculate an error (e.g., difference, deviance, etc.) between the predicted state of the surrounding vehicle and the actual measured state and continuously update the predicted state through the update. The error covariance may represent the uncertainty in the prediction and measurement of the state (e.g., trajectory, speed, etc.) of the surrounding vehicle, and may be used to evaluate the reliability of the estimated route.

That is, the error or error covariance may refer to a difference value caused by the processing noise and measurement noise when predicting the state of the surrounding vehicle.

The state of the surrounding vehicle may refer to a driving trajectory and may be defined by including a longitudinal position, a longitudinal speed, a lateral position, and a lateral speed.

For example, the first processing unit 131 may filter noise of the sensor through a Kalman filter and calculate an error covariance. The first processing unit 131 may estimate the trajectory of the surrounding vehicle and filter out noise, define measurement noise and process noise in Gaussian form, and estimate an error covariance.

The first processing unit 131 may predict the current state by using a previously collected state of the surrounding vehicle and a Kalman filter. The first processing unit 131 compares the actually measured state value of the surrounding vehicle with the predicted state value to correct the estimated value.

In this process, the first processing unit 131 defines a state vector representing the trajectory of the surrounding vehicle, which includes the trajectory of the surrounding vehicle, the longitudinal position, the longitudinal speed, the lateral position, and the lateral speed. This state vector refers to the state that the host vehicle tracks, including both the longitudinal and lateral positions and speeds of the surrounding vehicle.

The first processing unit 131 predicts the state at the next time step k using the current state of the surrounding vehicle and process noise, where the state change is represented by a transition matrix of the Kalman filter system, and process noise is added.

The process noise may reflect an unpredictable change that occurs when the Kalman filter system updates its state by itself, accounting for changes that the control system may not predict. For example, unexpected external factors such as wind, road conditions, and vehicle dynamic limitations while the vehicle is traveling may affect the prediction system. The variance of the process noise is expressed such that the noise follows a normal distribution with a mean of 0 and covariance Q, which indicates that unexpected changes may occur during the state update process.

Furthermore, the first processing unit 131 predicts a measured value for the object recognition information measured by the sensor when the state of the surrounding vehicle is predicted. In this prediction, the predicted measured value is obtained using a measurement model matrix that represents the relationship between the actual measured value and the system state, with measurement noise added. The measurement noise reflects that the sensor may not measure the surrounding environment perfectly, so there may be a difference between the actual state and the measured state. Its variance is expressed such that the noise follows a normal distribution with a mean of 0 and covariance R, reflecting the accuracy of the sensor and the magnitude of the measurement error.

The first processing unit 131 then calculates a predicted state error covariance matrix at the next time step based on the current error covariance matrix and the covariance matrix of the process noise. Using this error covariance matrix, the first processing unit 131 computes a Kalman gain, which is a weight determining how much the difference between the measured value and the predicted value should be reflected in the update. The Kalman gain is calculated using the transpose of the measurement model matrix and the covariance matrix of the measurement noise, reflecting the uncertainty between the predicted state and the measured values when updating the final state. The difference between the measured value and the predicted measured value is then reflected in the state of the surrounding vehicle, as predicted, using the Kalman gain as a weight, and the state of the surrounding vehicle is updated.

Finally, the error covariance matrix is updated by incorporating the unit matrix, reflecting the uncertainty of the updated state for use in the next step. In this manner, the first processing unit 131 continuously repeats the process of predicting and correcting the state of the surrounding vehicle over time by considering both the process noise and the measurement noise.

The second processing unit 132 may calculate a first safety boundary between the host vehicle and an external object using the object recognition information and the vehicle driving information, and reflect the error in the first safety boundary to calculate a second safety boundary.

For example, the second processing unit 132 may reflect the error covariance in the first safety boundary to calculate the second safety boundary.

In addition, the second processing unit 132 may calculate the first safety boundary based on a relative position and a relative speed of the surrounding object and the host vehicle, model the calculated first safety boundary in an elliptical shape, and reflect the error covariance as a margin area in the first safety boundary modeled in the elliptical shape to calculate the second safety boundary.

In addition, the second processing unit 132 may calculate (e.g., determine) the driving trajectory (also referred to as a driving path) of the host vehicle using the second safety boundary. In this case, the second processing unit 132 may calculate the driving trajectory (e.g., driving path) so that the host vehicle travels within the second safety boundary. For example, the second processing unit 132 may calculate the driving trajectory so that the probability that the host vehicle travels within the second safety boundary is greater than or equal to a preset threshold value.

That is, the second processing unit 132 may use object recognition information and vehicle driving information to probabilistically set a collision determination range between the host vehicle and the surrounding vehicle, and calculate the probability that the trajectory of the host vehicle is within a safe range based on the state and error covariance of the surrounding vehicle, thereby generating a driving route robust to uncertainty.

The second processing unit 132 may probabilistically calculate the possibility of collision with the surrounding vehicle.

The second processing unit 132 may define a state vector representing the trajectory (e.g., driving path) of the host vehicle as

$${ε}_{k}^{E V} = [ {s}_{k}^{E V} , {n}_{k}^{E V} , {v}_{s , k}^{E V} , {v}_{n , k}^{E V} ]$$

using vehicle driving information. In the state vector of the host vehicle, ξₖ^{E}^{_{V}} is a trajectory of the host vehicle, sₖ^{E}^{_{V}} is a longitudinal position of the host vehicle, v_{s,}^{E}^{_{V}} is a longitudinal speed of the host vehicle, nₖ^{E}^{_{V}} is a lateral position of the host vehicle, and v_{n,k}^{E}^{_{V}} is a lateral speed of the host vehicle.

The second processing unit 132 may calculate a lateral relative distance and a longitudinal relative distance using the state vector of the surrounding vehicle and the state vector of the host vehicle as in the following Equation 1.

$$Δ {s}_{k} = {s}_{k}^{E V} - {s}_{k}^{T V} , Δ {n}_{k} = {n}_{k}^{E V} - {n}_{k}^{T V} \qquad [ Equation 1 ]$$

In Equation 1, Δsₖ is a longitudinal relative distance between the host vehicle and the surrounding vehicle, and Δnₖ is a lateral relative distance between the host vehicle and the surrounding vehicle.

The second processing unit 132 may define an elliptical boundary model of the first safety boundary by reflecting a longitudinal safety distance and a lateral safety distance as in the following Equation 2.

$${d}_{k} = \frac{{( Δ {s}_{k} )}^{2}}{{a}_{s}^{2}} + \frac{{( Δ {n}_{k} )}^{2}}{{b}_{n}^{2}} - 1 \geq 0 , k ∈ [ 0 , N ] \qquad [ Equation 2 ]$$

In Equation 2, dₖ is a variable expressing whether the relative distance between the host vehicle and the surrounding vehicle is present outside the elliptical boundary, aₛ is a longitudinal safety distance (a minimum distance that the host vehicle has to secure in the longitudinal direction), and bₙ is a lateral safety distance (a minimum distance that the host vehicle has to secure in the lateral direction). The safety distance may be set and changed in advance depending on the driving environment, specifications of the host vehicle, and the like. The second processing unit 132 may prevent a collision by preventing the surrounding vehicle from entering the ellipse using the variable dₖ.

The second processing unit 132 may reflect a constraint condition according to the following Equation 3 in the elliptical boundary model to calculate the first safety boundary.

$${P}_{r} ( {ε}_{k}^{E V} ∈ {∃}_{k}^{s a f e t y} ) > ϵ , ϵ ∈ [ 0.5 , 1. ] \qquad [ Equation 3 ]$$

In Equation 3,

$${∃}_{k}^{s a f e t y}$$

refers to a space of a safe state in which the host vehicle does not collide with the surrounding vehicle, and ϵ refers to a lower limit of the probability that the trajectory of the host vehicle is present within a safe area. The second processing unit 132 may mean that the first safety boundary is designed so that the probability that the state of the host vehicle is within a safe state space where the host vehicle does not collide with the surrounding vehicle is greater than ϵ. That is, the possibility of collision may be reduced by ensuring that the probability that the host vehicle is present within the elliptical boundary is greater than or equal to ϵ. For example, ϵ may have a value between 0.5 and 1.0, and ϵ may be a parameter that sets a standard for how much safety has to be guaranteed.

The second processing unit 132 may calculate a boundary condition in which the process noise and measurement noise are reflected according to the following Equation 4.

$${d}_{k} + ∇ {d}_{k} {e}_{k}^{T V} \geq 0 , ( {e}_{k}^{T V} ∼ N ( 0 , {\sum }_{k}^{e} ) ) \qquad [ Equation 4 ]$$

In Equation 4, ∇dₖ is a partial differential vector

$$∇ {d}_{k} = [ \frac{- 2 Δ {s}_{k}}{{a}_{k}^{2}} , 0 , \frac{- 2 Δ {n}_{k}}{{b}_{n}^{2}} , 0 ]$$

of state variables

$${ε}_{k}^{TV}$$

of the host vehicle and the surrounding vehicle for a relative distance constraint dₖ. This vector represents how a relative position change between the host vehicle and the surrounding vehicle affects the safety distance dₖ.

$${e}_{k}^{T V}$$

represents an error with respect to the state of the surrounding vehicle.

$${e}_{k}^{T V}$$

is a variable that represents a difference between the predicted state of the surrounding vehicle and the actual measured state in the prediction model, that is, a state error.

$${e}_{k}^{T V} ∼ N ( 0 , {\sum }_{k}^{e} )$$

may mean that the state error of the surrounding vehicle is modeled as a normal distribution following a covariance matrix

$${\sum }_{k}^{e}$$

that has a mean of 0 and varies over time. That is, it indicates that the state error of the surrounding vehicle is 0 on average, the system has uncertainty, and thus, there is a possibility that an error may occur. The extent of the error may be defined by the covariance matrix

$${\sum }_{k}^{e} .$$

Equation 4 may be an equation that reflects the process noise and measurement noise in probabilistic modeling, and in this way, may allow the host vehicle to consider an error range when predicting the state of the surrounding vehicle and making a plan.

In this way, the second processing unit 132 may evaluate whether the distance between the host vehicle and the surrounding vehicle is still within a safe range by considering the process noise and measurement noise. That is, when dₖ is a distance constraint without noise,

$${d}_{k} {e}_{k}^{TV}$$

may refer to a distance constraint that reflects an additional distance change according to noise.

The second processing unit 132 may reflect the additional distance constraint and set a probability constraint condition according to Equation 5 so that the probability that the host vehicle is within a safe state space

$${∃}_{k}^{safety}$$

is greater than a preset threshold value ϵ.

$${P}_{r} ( {ε}_{k}^{E V} ∈ {∃}_{k}^{safety} ) > ϵ , ϵ ∈ [ 0.5 , 1.0 ] \qquad [ Equation 5 ]$$

In Equation 5,

$${ε}_{k}^{EV}$$

is a state vector of the host vehicle, and

$${∃}_{k}^{safety}$$

defines a safe state area, that is, an area where collision with the surrounding vehicle may be avoided.

$${P}_{r} ( {ε}_{k}^{EV} ∈ {∃}_{k}^{s afety} ) > ϵ$$

sets a condition that the probability that the state of the host vehicle is within a safe state area is greater than ϵ. Here, ϵ is a preset safety probability, and may usually have a value between 0.5 and 1.0. This may mean that the higher the value, the higher the level of safety is ensured.

The second processing unit 132 may set the second safety boundary by adding a correction according to the error of the surrounding vehicle to the first safety boundary.

$${d}_{k} \geq ∇ {d}_{k} {e}_{k}^{TV} \geq {γ}_{k} \qquad [ Equation 6 ]$$

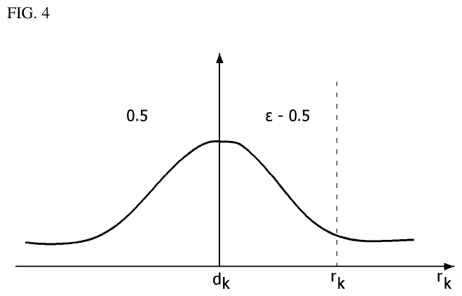

Referring to FIG. 4, in Equation 6, dₖ is a first safety boundary, and

$$\geq ∇ {d}_{k} {e}_{k}^{TV}$$

may refer to a second safety boundary that reflects an error

$${e}_{k}^{TV}$$

of a surrounding vehicle in the first safety boundary. γₖ defines a maximum range of the second safety boundary.

$${γ}_{k} = \sqrt{2 ∇ {d}_{k} {\sum }_{k}^{e} {( ∇ {d}_{k} )}^{T}} {erf}^{- 1} ( 2 ϵ - 1 ) \qquad [ Equation 7 ]$$

In Equation 7, γₖ represents a minimum safety margin between a host vehicle and the surrounding vehicle that is derived based on a state error covariance matrix

$${\sum }_{k}^{e}$$

estimated through the Kalman filter.

$$\sqrt{2 ∇ {d}_{k} {\sum }_{k}^{e} {( ∇ {d}_{k} )}^{T}}$$

is a safety boundary distance using the error covariance matrix calculated in the first processing unit 131, and the value represents a margin required for the host vehicle to reflect the state error of the surrounding vehicle and generate the second safety boundary in an elliptical shape.

erf⁻¹(2ϵ−1), which is an Erf error function, may be used to find the boundary distance according to a preset safety probability threshold value ϵ, and may probabilistically calculate the boundary distance and derive an appropriate margin to ensure the probability of non-collision. The error function plays an important role in calculating the probability constraint condition. The Erf function is used to calculate the probability of collision according to a normal distribution within a certain range. By the Erf function, the vehicle may set a route on which to safely travel without collision.

The second processing unit 132 may calculate a driving trajectory (e.g., of the host vehicle) so that the probability that the host vehicle travels within the second safety boundary is greater than or equal to a preset threshold value according to the following Equation 8.

$${P}_{r} = ( - ∇ {d}_{k} {e}_{k}^{TV} \leq {γ}_{k} ) > ϵ \qquad [ Equation 8 ]$$

In Equation 8, the state of the host vehicle has to satisfy a condition that the probability that the host vehicle is within the second safety boundary is greater than ϵ. That is, this means that, after correcting the state error caused by the process noise and measurement noise, the probability that the state of the host vehicle maintains a state of not colliding with the surrounding vehicle has to be greater than or equal to a set ϵ.

In this way, the possibility of collision may be minimized and a safe driving route may be calculated despite the uncertainty of the state of the surrounding vehicle according to noise.

In addition, the second processing unit 132 may determine a driving strategy based on a relative distance between the second safety boundary and the surrounding object.

The second processing unit 132 may generate an optimal route that may avoid collision with the surrounding vehicle using the second safety boundary generated under the aforementioned probability constraint condition.

The second processing unit 132 may calculate the second safety boundary in real time while the host vehicle is traveling along the route, and calculate the possibility of collision with the surrounding vehicle using the second safety boundary. The second processing unit 132 may calculate the possibility of collision with the surrounding vehicle by considering cases such as when the host vehicle leaves the second safety boundary, when the distance between the second safety boundary and the surrounding vehicle is equal to or less than a preset distance, when the surrounding vehicle enters the second safety boundary, or the like.

For example, when the Pr value of the aforementioned Equation 7 is lower than ϵ, the second processing unit 132 may recognize a current situation as a collision risk situation in which the probability that the host vehicle is located within the second safety boundary is low.

When the Pr value of the aforementioned Equation 7 is greater than ϵ, the second processing unit 132 may recognize the current situation as a safe situation in which the probability that the host vehicle is located within the second safety boundary is high.

The second processing unit 132 may determine a driving strategy such as lane keeping, deceleration, lane changing, acceleration, or the like, according to the probability that the host vehicle is located within the second safety boundary.

Specifically, the second processing unit 132 determines the driving strategy based on the calculated driving trajectory and controls the vehicle's behavior accordingly. The second processing unit 132 may control the behavior (e.g., one or more operations) of the host vehicle based on the lateral control and longitudinal control of the vehicle.

For example, when it is determined that the possibility that the host vehicle will collide within a current lane is low, the second processing unit 132 may determine the driving strategy so that the host vehicle travels while maintaining the existing route. In this case, driving continues without any significant changes in speed or direction. That is, as long as the probability constraint condition is satisfied, the driving strategy may be determined to continue to drive in a current lane according to route planning of the host vehicle.

For example, the second processing unit 132 may consider deceleration when the surrounding vehicle enters the second safety boundary or when the possibility of collision with a preceding vehicle increases. This is a measure to secure a longitudinal distance between the host vehicle and the preceding vehicle and maintain a safe state. The second processing unit 132 may determine whether to decelerate by reflecting the state of the surrounding vehicle estimated by the Kalman filter.

For example, the second processing unit 132 may consider changing lanes when the possibility that the host vehicle collides with the surrounding vehicle in the current lane increases (e.g., when the surrounding vehicle suddenly enters the driving lane of the host vehicle or a speed difference occurs). In this case, the second processing unit 132 may calculate whether to change lanes, an entry speed, and the like, by considering a distance between another surrounding vehicle located in an entry candidate lane and the second safety boundary.

For example, the second processing unit 132 may determine acceleration when it is determined that the risk of collision is low and it is safe for the host vehicle to travel at a higher speed. In particular, when a distance to the preceding vehicle in the driving lane is sufficient and there is no change in the state of other vehicles, the second processing unit 132 increases a driving speed through acceleration. In this case, it is possible to check that there is no possibility of collision even after acceleration based on the state of the preceding vehicle and the expected route estimated by the Kalman filter.

The second processing unit 132 may plan the driving route so as not to deviate from the second safety boundary, and may immediately reset the driving strategy when a change in situation occurs, such as the surrounding vehicle entering the second safety boundary.

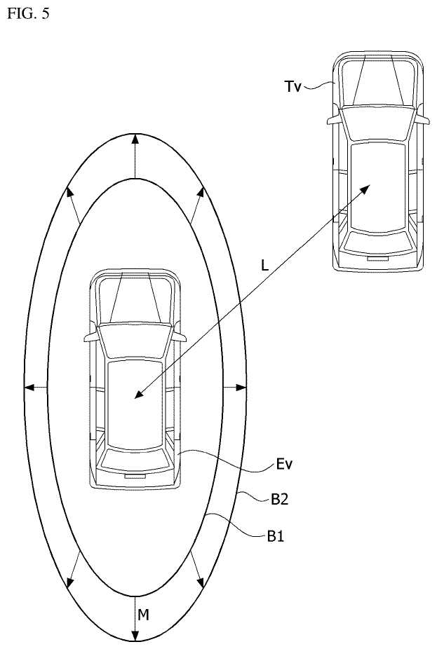

FIG. 5 is a diagram for describing the operation of the display 108.

Referring to FIG. 5, the second processing unit 132 may perform control to display a host vehicle, a surrounding object, and a second safety boundary through the display 108.

In FIG. 5, the second processing unit 132 sets and displays an elliptical second safety boundary B2 based on a distance L from a center point of a host vehicle Ev to a center point of a surrounding vehicle Tv. This elliptical boundary represents a probabilistically safe distance, and the route is generated in such a way that maximizes the probability that the host vehicle Ev is located within the boundary.

The second safety boundary B2 is a minimum safety distance at which the host vehicle Ev has to secure to prevent the host vehicle Ev from colliding with the surrounding vehicle Tv, and is derived based on a first safety boundary B1 and a safety margin M based on an error covariance obtained from the Kalman filter. That is, the greater the error covariance, the greater the uncertainty about the state of the surrounding vehicle, and accordingly, the greater the safety distance is set.

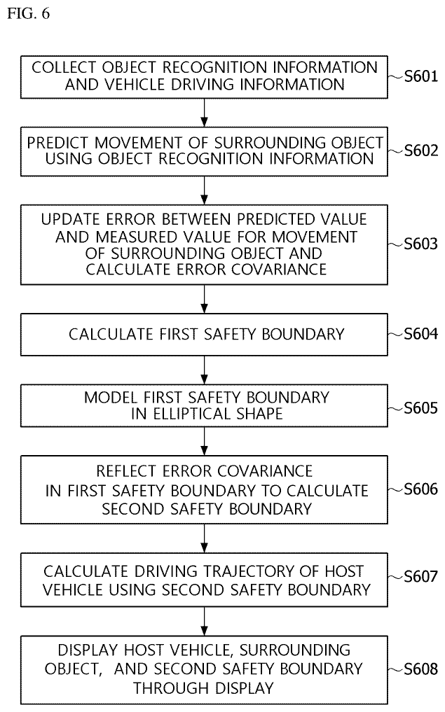

FIG. 6 is a flowchart of a method of controlling a vehicle.

Referring to FIG. 6, first, the sensor collects object recognition information obtained by recognizing an external object and vehicle driving information about the host vehicle (S601).

The processor predicts the movement of a surrounding object using the object recognition information (S602).

The processor updates an error between a predicted value and a measured value for the movement of the surrounding object using the collected object recognition information and calculates an error covariance (S603).

The processor calculates a first safety boundary between the host vehicle and the external object (e.g., the surrounding vehicle) using the object recognition information and the vehicle driving information (S604).

The processor models the first safety boundary in an elliptical shape (S605).

The processor reflects the error covariance in the first safety boundary to calculate a second safety boundary. The processor reflects the error covariance in the first safety boundary modeled in the elliptical shape as a margin area to calculate the second safety boundary (S606).

The processor calculates a driving trajectory of the host vehicle using the second safety boundary (S607).

The processor displays the host vehicle, the surrounding object, and the second safety boundary through the display. In this case, the processor may perform control to also display the driving trajectory of the host vehicle (S608).

According to an aspect of the present disclosure, there is provided a vehicle control device including one or more processors and a memory configured to store one or more programs executed by the one or more processors, in which the processor is configured to determine the movement of a surrounding object using object recognition information in which an external object is recognized by a sensor unit and determine a driving trajectory according to a safety boundary between a host vehicle and the external object using the movement of the surrounding object and vehicle driving information about the host vehicle collected by the sensor unit.

The processor may predict the movement of the surrounding object using the object recognition information and update an error between a predicted value and a measured value when the object recognition information is collected to calculate an error covariance.

The processor may calculate a first safety boundary between the host vehicle and the external object using the object recognition information and the vehicle driving information and reflect the error covariance in the first safety boundary to calculate a second safety boundary.

The processor may calculate the first safety boundary based on a relative position and a relative speed of the surrounding object and the host vehicle and model the first safety boundary in an elliptical shape.

The processor may reflect the error covariance as a margin area in the first safety boundary modeled in the elliptical shape to calculate the second safety boundary.

The processor may calculate the driving trajectory of the host vehicle using the second safety boundary.

The processor may calculate the driving trajectory so that the host vehicle travels within the second safety boundary.

The processor may calculate the driving trajectory so that a probability that the host vehicle travels within the second safety boundary is greater than or equal to a preset threshold value.

The processor may determine a driving strategy according to a relative distance between the second safety boundary and the surrounding object.

The processor may perform control to display the host vehicle, the surrounding object, and the second safety boundary through a display.

According to another aspect of the present disclosure, there is provided a method of controlling a vehicle, including collecting object recognition information about an external object and vehicle driving information about a host vehicle that are recognized by a sensor unit, determining, by a processor, the movement of a surrounding object using the object recognition information, and determining a driving trajectory according to a safety boundary between the host vehicle and the external object using the movement of the surrounding object and the vehicle driving information.

The calculating of the error may include predicting the movement of the surrounding object using the object recognition information and updating an error between a predicted value and a measured value when the object recognition information is collected to calculate an error covariance.

The calculating of the second safety boundary may include calculating a first safety boundary between the host vehicle and the external object using the object recognition information and the vehicle driving information and reflecting the error covariance in the first safety boundary to calculate a second safety boundary.

The calculating of the first safety boundary may include calculating a first safety boundary based on a relative position and a relative speed of the surrounding object and the host vehicle and modeling the first safety boundary in an elliptical shape.

The calculating of the second safety boundary may include reflecting the error covariance as a margin area in the first safety boundary modeled in the elliptical shape to calculate the second safety boundary.

The method may further include calculating, by the processor, the driving trajectory of the host vehicle using the second safety boundary.

The calculating of the driving trajectory may include calculating the driving trajectory so that the host vehicle travels within the second safety boundary.

The calculating of the driving trajectory may include calculating the driving trajectory so that a probability that the host vehicle travels within the second safety boundary is greater than or equal to a preset threshold value.

The calculating of the driving trajectory may include determining a driving strategy according to a relative distance between the second safety boundary and the surrounding object.

The method may further include displaying the host vehicle, the surrounding object, and the second safety boundary through a display according to control of the processor.

A vehicle control device according to the present disclosure and a method of controlling a vehicle can generate a safe route by considering sensor noise and uncertain movements of surrounding vehicles.

In addition, the vehicle control device and the method of controlling a vehicle can ensure safe driving even in complex scenarios such as lane changing or avoidance in a narrow space.

In addition, the vehicle control device and the method of controlling a vehicle can be applied to various situations by reflecting the actions of surrounding vehicles such as acceleration, deceleration, lane changing, and the like.

In addition, in this way, the vehicle control device and the method of controlling a vehicle can improve the safety and reliability of autonomous driving.

Although the example embodiments of the present disclosure have been described herein, it is understood that those skilled in the art can make various changes and modifications to the present disclosure without departing from the spirit and scope of the present disclosure set forth in the claims below.

What is claimed is:

1. A device for controlling a vehicle, the device comprising:
one or more processors; and
a memory storing at least one instruction that is configured, when executed by the one or more processors communicating with the memory, to cause the device to:
determine, based on an external object detected by one or more sensors of the vehicle, movement of the external object;
determine, based on the movement of the external object, based on vehicle driving information of the vehicle, and based on a safety boundary between the vehicle and the external object, a driving path of the vehicle; and
control, based on the driving path, an autonomous driving operation of the vehicle.

2. The device of claim 1, wherein the at least one instruction is configured, when executed by the one or more processors communicating with the memory, to further cause the device to:
determine, based on first object information of the external object measured via the one or more sensors at a first time, a predicted movement value of the external object;
determine a measured movement value by measuring, via the one or more sensors at a second time later than the first time, second object information of the external object; and
determine, based on a difference between the predicted movement value and the measured movement value, an error covariance.

3. The device of claim 2, wherein the at least one instruction is configured, when executed by the one or more processors communicating with the memory, to further cause the device to:
determine, based on the first object information and the vehicle driving information, a first safety boundary between the vehicle and the external object; and
determine a second safety boundary by applying the error covariance to the first safety boundary, and
wherein the safety boundary between the vehicle and the external object is determined based on the second safety boundary.

4. The device of claim 3, wherein the at least one instruction is configured, when executed by the one or more processors communicating with the memory, to cause the device to determine the first safety boundary by:
determining the first safety boundary based on a position and a speed of the external object relative to the vehicle, and
wherein the first safety boundary is modeled in an elliptical shape.

5. The device of claim 3, wherein the at least one instruction is configured, when executed by the one or more processors communicating with the memory, to cause the device to determine the second safety boundary by:
applying the error covariance to the first safety boundary as a margin area.

6. The device of claim 3, wherein the at least one instruction is configured, when executed by the one or more processors communicating with the memory, to cause the device to determine the driving path of the vehicle based on the second safety boundary.

7. The device of claim 3, wherein the at least one instruction is configured, when executed by the one or more processors communicating with the memory, to cause the device to determine the driving path by:
determining the driving path so that the vehicle travels within the second safety boundary.

8. The device of claim 3, wherein the at least one instruction is configured, when executed by the one or more processors communicating with the memory, to cause the device to determine the driving path by:
determining the driving path so that a probability that the vehicle travels within the second safety boundary is greater than or equal to a threshold value.

9. The device of claim 3, wherein the at least one instruction is configured, when executed by the one or more processors communicating with the memory, to further cause the device to:
determine, based on a distance between the second safety boundary and the external object, a driving strategy.

10. The device of claim 1, wherein the at least one instruction is configured, when executed by the one or more processors communicating with the memory, to cause the device to control the autonomous driving operation of the vehicle comprises:
displaying, via a display device of the vehicle, an indication of the vehicle, an indication of the external object, and an indication of the safety boundary,
wherein the safety boundary is determined based on at least one of: a first probability value associated with one or more sensing errors of the one or more sensors or a second probability value associated with one or more prediction errors of the driving path.

11. A method performed by an apparatus of a vehicle, the method comprising:
obtaining, from one or more sensors of the vehicle, object information of an external object and vehicle driving information of the vehicle;
determining, based on the object information, movement of the external object;
determining, based on the movement of the external object, based on the vehicle driving information, and based on a safety boundary between the vehicle and the external object, a driving path of the vehicle; and
controlling, based on the driving path, an autonomous driving operation of the vehicle.

12. The method of claim 11, wherein the obtaining of the object information comprises:
determining, based on first object information of the external object measured via the one or more sensors at a first time, a predicted movement value of the external object;
determining a measured movement value by measuring, via the one or more sensors at a second time later than the first time, second object information of the external object; and
determining, based on a difference between the predicted movement value and the measured movement value, an error covariance.

13. The method of claim 12, further comprising:
determining, based on the first object information and the vehicle driving information, a first safety boundary between the vehicle and the external object; and
determining a second safety boundary by applying the error covariance to the first safety boundary,
wherein the safety boundary between the vehicle and the external object is determined based on the second safety boundary.

14. The method of claim 13, wherein the determining of the first safety boundary comprises:
determining the first safety boundary based on a position and a speed of the external object relative to the vehicle, and
wherein the first safety boundary is modeled in an elliptical shape.

15. The method of claim 13, wherein the determining of the second safety boundary comprises:
applying the error covariance to the first safety boundary as a margin area.

16. The method of claim 13, wherein the determining of the driving path comprises:
determining the driving path of the vehicle based on the second safety boundary.

17. The method of claim 13, wherein the determining of the driving path comprises:
determining the driving path so that the vehicle travels within the second safety boundary.

18. The method of claim 13, wherein the determining of the driving path comprises:
determining the driving path so that a probability that the vehicle travels within the second safety boundary is greater than or equal to a threshold value.

19. The method of claim 13, further comprising:
determining, based on a distance between the second safety boundary and the external object, a driving strategy.

20. A vehicle comprising:
one or more sensors;
one or more processors; and
a memory storing at least one instruction that is configured, when executed by the one or more processors communicating with the memory, to cause the vehicle to:
determine an autonomous driving path of the vehicle;
determine, based on an external object detected by the one or more sensors, movement of the external object;
determine, based on the movement of the external object and based on vehicle driving information of the vehicle, a safety boundary between the vehicle and the external object, wherein the safety boundary is determined based on at least one of: a first probability value associated with one or more sensing errors of the one or more sensors or a second probability value associated with one or more prediction errors of the autonomous driving path;
adjust, based on the safety boundary, the autonomous driving path; and
control, based on the adjusted autonomous driving path, an autonomous driving operation of the vehicle.
